(19) United States
(12) Patent Application Publication
(10) Pub. No.: US 2014/0226774 A1
(43) Pub. Date: Aug. 14, 2014

(54) PRODUCTION OF ACTINIUM-227 AND THORIUM-228 FROM RADIUM-226 TO SUPPLY ALPHA-EMITTING ISOTOPES RADIUM-223, THORIUM-227, RADIUM-224, BISMUTH-212

(71) Applicants: Marlene Schenter, Portland, OR (US); THORENCO MEDICAL ISOTOPES LLC, San Francisco, CA (US)

(72) Inventors: Charles S. Holden, San Francisco, CA (US); Robert E. Schenter, Portland, OR (US)

(73) Assignee: THORENCO MEDICAL ISOTOPES LLC, San Francisco, CA (US)

(21) Appl. No.: 14/152,805

(22) Filed: Jan. 10, 2014

Related U.S. Application Data
(60) Provisional application No. 61/751,208, filed on Jan. 10, 2013.

(51) Int. Cl. G21G 1/00

(52) U.S. Cl. CPC G21G 1/001; G21G 2001/0089
USPC 376/170

(57) ABSTRACT

An actinium-227 production device having a plurality of metallic or ceramic caplets, each enclosing a radium-226 compound in redundantly nested sealed cylinders. The radium-226 compound is compacted into a disk and diluted with heat transporting ceramic materials. A thermal neutron shield including spectrum shaping materials to protect actinium-227 produced from exposure to thermal neutrons is included along with a strong neutron absorber to shape the neutron spectrum such that radium-226 nuclei are exposed to neutrons in the higher epithermal energy groups upon entry into the target with an energy of between 20 eV and 1 KeV.

### CROSS REFERENCES TO RELATED APPLICATIONS

The present application claims the benefit of U.S. Provisional Patent Application Ser. No. 61/751,208, filed Jan. 10, 2013 (Jan. 10, 2013), and U.S. Provisional Patent Application Ser. No. 61/650,355, filed May 16, 2013 (May 16, 2013).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

### Field of the Invention

The present invention relates generally to a device to make medical isotopes. This application discloses methods, geometries and materials for devices suitable for the irradiation of radium-226 for the production of actinium-227. This application discloses a novel production target designed make scarce alpha emitting medical isotopes more widely available. Neutron irradiation of radium-226 produces actinium-227 and thorium-228. Actinium-227 with a half life of almost 22 years and thorium-228 with a half life of almost 2 years are produced in the target disclosed. These two isotopes are parents or precursors of valuable medical isotopes. Their daughter isotopes emit one to five energetic but short ranged alpha particles, helium nuclei that transit only two to ten cell diameters depositing approximately 5 MeV over this short distance. The alpha emitters are: thorium-227, radium-223 and radium-224 and bismuth-212.

Generally radium-226 is irradiated with epi-thermal neutrons in a target containing radium-226 carbonate in a set of sealed sources, the target is opened and it is processed using radiochemical separations techniques. The actinium-227, the thorium-228 and the remaining radium-226 are separated from each other, are purified and stockpiled. Later, pure actinium-227 is milked for recovery of either radium-223 or thorium-227. Also, pure thorium-228 is milked for radium-224 which decays to lead-212 that generates bismuth-212. Radium-226 that is recovered from the irradiated material is recycled and used again in new targets. The half lives of alpha emitting isotopes generated by the decay of actinium-227 and thorium-228 have durations that make them useful as active pharmaceutical ingredients for a class of targetable new drugs for the treatment of cancer and other disorders.

The inventive target uses a tailored neutron spectrum that interacts with radium-226 in a way that suppresses production of less desirable thorium-228. The energy groups of neutrons most suitable by capture by nuclei of radium-226 but not suitable for capture by nuclei of produced actinium-227 are neutrons are in the epithermal energy groups with the most useful neutrons being in the epithermal energy groups less than 1 KeV and greater than 50 eV. Epithermal neutrons in these energy groups have good capture cross sections for nuclei of radium-226 but comparatively poor capture cross sections for nuclei of actinium-227. Thus, in the well tailored epithermal neutron spectrum, the nuclei of produced actinium-227 are less likely to capture neutrons to become nuclei of thorium-228. When the spectrum is shaped so that radium-226 nuclei mostly “see” epi thermal neutrons between one KeV and 50 eV, production of thorium-228 is suppressed and production of actinium-227 is increased. Protecting the produced actinium-227 from exposure to thermal neutrons is desirable since fewer atoms of actinium-227 will be able to capture neutrons to become short lived actinium-228 which quickly decays to thorium-228. Actinium-227's neutron capture cross section for neutrons in the elevated epithermal energy groups is much lower in the 1 KeV to 50 Ev range than for neutrons in the less energetic energy groups in and near the thermal neutron energy groups, 0.025 eV. The difference in actinium-227's neutron capture probabilities between the thermal neutrons and higher energy epithermal ranges on the average exceeds one order of magnitude. Because this difference in neutron capture cross-sections is substantial, significant benefit results from tailoring the neutron spectrum so that neutrons between 1 KeV and 50 eV are made to be those most likely to interact with radium-226 nuclei so that the produced actinium-227 is conserved. This shaping of the neutron spectrum or flux tailoring reduces the co-production of thorium-228 (the first decay product of short lived actinium-228 which is the neutron capture product of actinium-227). By reducing the co-production of thorium-228, during a long irradiation more useful actinium-227 becomes available and scarce radium-226 is conserved. The other factor is to limit irradiation time to minimize production of thorium-228.

Alternatively, if production of thorium-228 becomes more desirable than production of actinium-227, then the neutron spectrum that interacts with the target material can be tailored so that the epithermal neutron population is decreased and the thermal neutron population is increased. Additionally the target material can be configured to enhance self shielding effects to promote double neutron capture. These modifications produce greater production of thorium-228.

The disclosed target device is designed to irradiate compacted radium-226 carbonate. Compacted carbonate is used because voids between the particle grains conveniently provide plenum volume for helium-4 generated by the continuous decay of radium-226 and the continuous decay of most of its decay daughters. The plenum volume between the grains of target material provides adequate space for radon-222 also generated from the decay of radium-226 as well as for helium-4. Additional plenum volume is provided as “head space” by the geometry of each caplet that encloses a disk or other shape: hexagonal octagonal, square, rectangular or trapezoidal of compacted radium-226 carbonate.

Compacted radium-226 carbonate is a convenient form of radium-226 to process after irradiation and is selected because it is insoluble in water, a target material suitable for use in water cooled production reactors. Use of radium-226 carbonate simplifies post-irradiation chemical separations steps in which actinium-227 is separated from the radium-226 and thorium-228. Compacted radium-226 carbonate has the additional advantage of being easily dissolved in several solutions after irradiation. Irradiating dispersed radium-226 in carbonate is advantageous because self shielding effects are reduced because atoms of radium-226 are spread out, and are present in a reduced density compared to the density of atoms of metallic radium-226. Lower density reduces probabilities of a second neutron capture (so that less thorium-228 is produced.) Finally, before compaction, the carbonate powder can be mixed with other powders, powdered silicon dioxide, to reduce self shielding, powdered aluminum nitride or powdered cubic boron arsenide for heat transport, or a powdered lanthanide oxide or any hydride to reduce neutron energy in the target from fast to epithermal. A selected lanthanide oxide powder of a strong neutron absorber can be used for thermal neutron shielding along with a cover foil or tube that captures thermal neutrons. These strong neutron absorber materials can be erbium or europium in oxide form or other chemical form.

One focus of the innovation disclosed is to maximize actinium-227 production by the use of neutrons in the higher epi thermal energy groups for the irradiation of radium-226. For the purpose of this patent application, the thermal energy region is defined as 1/1000 electron volts to 5/10 electron volts, the epi thermal energy region is 5/10 electron volts to 5000 electron volts, the fast energy region as five thousand electron volts (five kilovolts, 5 KeV) to one million electron volts (1 MeV) and the high energy region as above 1 MeV. The optimal energy for transmutation of radium-226 to actinium-227 is in the higher region of the epi thermal spectrum, between one kilovolt (1 KeV) and fifty electron volts (50 Ev.) At lower energy, neutrons below 50 eV, probabilities for neutron capture by actinium-227 increase significantly over probabilities for neutron capture by radium-226 for the most part. These lower neutron energy groups are to be avoided when the object is to make actinium-227 from radium-226.

The target disclosed in this application is more efficient because the rate of production of actinium-227 from radium-226 is increased over other methods which use essentially only thermal neutrons. The novel production device disclosed also reduces the production of less desirable actinium-228 that rapidly decays to thorium-228. This objective is achieved by shaping the neutron spectrum of the neutrons which interact with radium-226 to the higher epithermal range so that the produced actinium-227 nuclei are exposed to as few thermal neutrons as possible. So long as actinium-227 nuclei “see” epithermal neutrons in the right energy groups and not thermal neutrons, production of thorium-228 will be reduced. If, however the production is thorium-228 is desired, neutron spectrum tailoring can be adjusted to maximize production of this isotope by irradiating radium-226 in the thermal spectrum. The density of radium-226 atoms can be increased to increase self shielding effects (using metallic radium-226 beads in the central region of the target instead of powdered, compacted and diluted radium-226 carbonate). The spectrum of the interacting neutrons can be tailored by introducing more hydrogenous moderating material in and around the target to make epithermal neutrons more scarce and thermal neutrons more plentiful. This promotes double neutron capture by radium-226 is to increase production of thorium-228.

### Background Discussion

By using higher energy epithermal neutrons for the transmutation of radium-226 to actinium-227 and by using strong thermal neutron absorbers to protect the produced actinium-227 to shield actinium-227 from as many thermal neutrons as possible and by irradiating compacted, powdered target materials, the efficiency of actinium-227 production is enhanced. Radium-226 is converted to actinium-227 more quickly because neutron captures in radium-226 nuclei are more likely when the incident energy of the of the incoming neutrons in the radium containing target material is approximately 1 KeV and as neutrons slow down in the target materials from 1 KeV, the probabilities for capture by radium-226 improve until neutrons are slowed below 50 eV and at this threshold probabilities commence to become more elevated for neutron capture by produced actinium-227. One innovation is to tailor the neutron spectrum so that the neutron population the radium-226 atoms “see” in the target is kept above 50 eV and below 1 KeV to make actinium-227.

The other leading innovation disclosed in this application is a new type of sealed capsule. This sealed source is designed to be “radon tight.” Radon-222 is the first decay daughter of radium-226. It is a radioactive gas with a half life of 3.8 days. Radon-222 must be contained in the target if the target is to be approved for irradiation for the 5-10 weeks of irradiation needed for production of actinium-227. The use of compacted powders in the target provides a physical environment, plenum space in the voids between the particle grains to receive atoms of helium-4 and radon-222 which are constantly generated by radium-226's decay. Radon-222 is kept inside the target by the use of a group or set of radium-226 carbonate containing caplets. Sealed source caplets are the first line of defense. Caplets are small, hollow, finely machined metal disks that are fitted together and welded shut, forming a leak tight enclosure, that are qualified as sealed sources. Each caplet is separately welded shut after being loaded with the compacted radium-226 containing disk. A stack of sealed caplets (arranged like a roll of coins) is enclosed in a set of nested set of cylinders each being welded shut or otherwise sealed. Enclosure by nested, redundant metal sealed cylinders with activated charcoal provided in the top and bottom ends of the cylinders provides a secondary plenum for any radon-222 that may leak from or escape from any caplet. The nested cylinders provide redundant enclosures that reduce the risk that radon gas will leak from the capsule during storage, transportation and during irradiation. The caplets and the tubing can be fashioned from aluminum alloy (aluminum-6061), zirconium alloy (zircalloy), qualified stainless steel alloys (HT-9, SS-316) or titanium alloys as well as other alloys used for sealed sources. The alloy used for qualified sealed sources is the most likely enclosure alloy. Further, nested cylinders to contain the caplets can be fashioned from silicon carbide or other ceramic materials that are radon tight including aluminum nitride aluminum titanate.

One additional feature of this invention is that the assembly in which radium-226 is irradiated contains engineered amounts of strong thermal neutron absorbers to capture thermal neutrons so that actinium-227 is exposed to fewer thermal neutrons during periods of lengthy irradiation. Actinium-227 production rates are higher when epithermal neutrons between 1 KeV and 50 eV interact with radium-226. Strong neutron absorbers such as erbium or europium in oxide form or metallic foil form can be used to shape the spectrum so that few thermal neutrons interact with actinium-227.

Production is further enhanced by the use of intermetalic hydrides or deuterides in other plenum spaces around the inventive target. These hydrides in engineered amounts conveniently slow fast neutrons to desirable epithermal energy ranges just above 1 KeV.

Strong thermal neutron absorbers used with selected hydrides efficiently manage and tailor the energy groups of the neutrons interacting with radium-226 so that fast neutrons are slowed to the epithermal range and thermal neutrons are captured by absorbers near the target material. Use of these methods at the same time enhances production of actinium-227.

Other methods of production of actinium-227 discussed in the literature or otherwise commonly known use thermal neutrons for irradiation of radium-226. These methods cause significant numbers of neutron captures by actinium-227 producing more thorium-228. Actinium-227 has a much higher capture cross section for thermal neutrons than radium-226 does for most of the neutron energy groups below 20 Ev. By shielding the interior target volume containing radium-226 from these thermal neutrons, a more efficient method of producing actinium-227 becomes available. The materials and geometry of target components used to do this are the heart of the innovation disclosed in this application.

### Discussion of Background Art

The general principles governing production of radium-223 from radium-226 are reported in the literature. Roy Larsen et al in “Preparation and Use of Radium-223 to Target Calcified Tissues for Pain Palliation, Bone Cancer Therapy and Bone Surface Conditioning for” issued Oct. 21, 2003 as U.S. Pat. No. 6,635,234, discloses the value of radium-223 for treatment of many types of cancer. Also disclosed by Roy Larsen et al in “Thorium-227 for Use in Radiotherapy of Soft Tissue Disease” issued Feb. 26, 2008 U.S. Pat. No. 7,335,154 is the promise of using thorium-227 for various medical indications. In these disclosures and others dealing with radium-223 and thorium-227 no mention is made of the methods that can be used to produce pure and uniform actinium-227 by use of epithermal neutrons, spectrum shaping materials, by providing trapping media for radon-222 control and a unique caplet and nested tube geometry for the target to accomplish neutron spectrum shaping using strong neutron absorbers and hydrides to generate more epithermal neutrons in the vicinity of the radium-226. The literature does not disclose use of radon trapping media activated charcoal to manage radon gas before during and after irradiation.

The earliest patent discussion in the patent literature concerning the use of neutron absorbers in isotope production targets is found in “Neutron Irradiation Process for Producing Radioisotopes wherein Target Isotope is shielded from Thermal Neutrons” U.S. Pat. No. 3,269,915, issued on Aug. 30, 1966 to Jackson A. Ransohoff. The '915 patent discloses the use of neutron absorbing material in targets used to produce isotopes whose thermal neutron capture cross sections is significantly greater than the parent isotope. There is ample discussion throughout this application on the preparation of actinium-227 from radium-226. What is disclosed by Ransohoff is a type of cladding that is “black” to thermal neutrons. The black cladding is comprised of cadmium, samarium and/or gadolinium. Its thickness is adjusted so that enough neutron absorbing material is present throughout an irradiation. The black cladding disclosed is a cylinder of neutron absorbing material surrounding the target material with a lower neutron capture cross section than the produced material: neptunium-237, radium-226 or gold-197. Further there is discussion on the use of hydrides in the target as a moderator material to convert high energy neutrons to useful neutrons at lower energies. In the instant disclosure use of erbium and europium is made in contrast to the black cladding materials disclosed by Ransohoff. Little further mention of these innovations is found in more recent the literature. In “Neutron Source”, U.S. Pat. No. 4,208,247 to Albert J. Impink, there is disclosure of a neutron source or neutron generator used for the start up on a nuclear reactor. This device unlike other neutron generators remains in the reactor during operations. Advancing the use of the “black cladding”, cladding is opaque to thermal neutrons; this form of generator is shielded from thermal neutrons. It uses plutonium-238 as an alpha source for the product of neutrons by the alpha, n method on beryllium. Without the use of the “black cladding” the plutonium-238 would absorb thermal neutron at a high rate, so that soon plutonium-238 would be depleted and the neutron source would cease adequate neutron production since source of alpha particles to act on beryllium to generate neutrons is transmuted away. This is the background in the literature from published patents.

### Medical Isotope Informational Background

Radium-223, chelated thorium-227 or chelated lead-212 are administered by intravenous injection to cancer patients. Lead-212 decays to bismuth-212 which emits a single energetic alpha particle. In contrast, thorium-227 and radium-223 emit a cascade of energetic alpha particles. The alphas sever double strands of DNA in the nucleus of the cancer cell. All of the decay energy, in the range of five million electron volts (5 MeV) for each emitted alpha particle is deposited over a very short distance, two to ten cell diameters from the cell where the alpha is emitted. The energetic alpha particles damage cancer cells by ionizing molecules inside the cancer cell. The localized disturbance is generated by the rapidly moving alpha particles as they break chemical bonds in the cells within two to ten cell diameters of their point of origin. Within targeted cancer cells, double strands of DNA in the nucleus of the cancer cells are severed by the effects of the fast moving alpha particles. Once the double strands are severed, the cancer cells' genetic information is lost, causing these cancer cells to lose the ability to divide and to replicate.

Some primary cancer tumors metastasize by establishing secondary tumors within bone tissue. Among these, are prostate cancers, breast cancer, and some forms of lung cancer and kidney and urinary cancer and multiple myeloma. When cancer “spreads” to the bones, a lethal and painful burden is placed on the patient. Generalized radiation, chemotherapy, and surgery are not the most efficacious treatment options.

Thorium-227 and radium-223 have many therapeutic uses for the treatment of many forms of cancer and perhaps even for the treatment of recalcitrant infectious diseases that no longer respond to antibiotics. Radium-223 is used for the treatment of metastatic cancers that “spread” to bone tissue. Radium naturally “seeks” active bone because it follows the metabolic pathways that calcium uses in humans and mammals. Importantly also thorium-227 and radium-223 can be combined with various molecular targeting agents that seek and attach to specific cancer cells in primary tumors.

Thorium-227 decays with an alpha cascade of 5 alpha particles. Radium-223 decays with an alpha cascade of 4 alpha particles. Radium-224 decays with an alpha cascade of 4 alpha particles and bismuth-212 has one alpha decay. The half lives of the various alpha emitters vary: 18.75 days for thorium-227, 11.43 days for radium-223, and 3.66 days for radium-224 and 10 hours for lead-212 the precursor of bismuth-212. The alpha radiation from these isotopes provides a precise method to deliver highly localized radiation doses to cancer cells or to pathogens. Alpha radiation disrupts the ability of targeted cells to replicate. Because the alpha particles do not travel very far, two to ten cell diameters, 100 microns, the patient's healthy tissues are spared in contrast to chemotherapy and other forms of radiation in use.

Radium-223 treatment involves injecting the patient with a very small amount of this isotope that is carried to the bloodstream by a standard sterile saline solution. Radium-223 ions in the bloodstream seek bone because radium mimics calcium in the human and the mammalian body. Four energetic alpha particles cascade from the radium-223 atoms and the atoms of its decay daughters. The energetic helium nuclei, the alphas, attack the targeted cells within two to ten cell diameters from where the radium-223 atoms are incorporated into cancerous bone tissue. Radium-224 will act chemically like radium-223. It too will seek out bone and expose cancer cells that have spread to bone to alpha radiation. Radium-224 has a shorter half-life and may be administered more frequently than radium-223.

Lead-212 and Thorium-227 are used with molecular targeting agents that seek and attach to a unique or over expressed receptor of the targeted cancer cell. Lead-212 and thorium-227 can be chelated to special molecules that anchor to cancerous cells as well as those which target a particular receptor.

The foregoing background discussion reflects the current state of the art of which the present inventors are aware. Reference to, and discussion of, these patents is intended to aid in discharging Applicants' acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein. A review of the known art reveals no discussion of the use of compacted granular aluminum nitride or other heat conducting ceramic, or ceramic materials to enclose the caplets within a sealed target using redundant barriers. No mention is made of ceramics used to make useful isotopes to dilute the target material and to transport heat from the target material to the outside of the target using heat transporting ceramic, aluminum nitride, cubic boron arsenide or silicon carbide or graphite to conduct heat from the target's interior to its outer wall.

### BRIEF SUMMARY OF THE INVENTION

The novel production device disclosed in this application reveals that commercial scale actinium-227 production is made possible by the use of many features disclosed in this application. The complexity associated with the irradiation of radium-226 is illustrated in FIG. 8. This diagram shows many of the reactions that occur when radium-226 is irradiated with neutrons of multiple energy groups. Three decay chains are involved: one of radium-226, one of actinium-227 and one of thorium-228. The complexity of dealing with three decay chains at the same time is managed by the various techniques disclosed in this application:

First, Actinium-227 production from radium-226 is enhanced when selected energy groups in the epithermal range between 20 eV and 1 KeV are used. Production is enhanced because the neutron spectrum is tailored so that the neutrons that interact with radium-226 are above 20 eV and below 1 KeV. The target's placement in the core of the production reactor is very important. The target must be in a reactor position that has a high overall population of neutrons in higher or fast energy groups so that tailoring methods shape the neutron spectrum so that it has a high proportion of epithermal neutrons in the range between 1 KeV and 20 eV.

Second, self-shielding effects are reduced by the use of compacted, powdered radium-226 carbonate to disperse radium-226 atoms among neutronically inert atoms, compacted and powdered aluminum nitride, alumina, or silicon dioxide or silica or zirconium oxide, zirconia, for example. The radium-226 containing media is placed in the central region of the production device within inventive caplets. The caplets divide the radium-226 mass to reduce the likelihood that a significant quantity of radon-222 will leak from the target assembly into reactor spaces. Because the atoms of radium-226 are dispersed in radium-226 carbonate and this media can be further diluted with heat transport media such as aluminum nitride or cubic boron arsenide which blend can be further diluted with alumina, silica, or zirconia so that probabilities for double neutron capture are reduced as the density of radium-226 atoms in the target media are reduced.

Third, the preferred geometry is selected. In this geometry the compacted radium-226 carbonate and the other compacted powders are arrayed in compacted disks enclosed by the caplets within three or more nested metallic or ceramic cylinders. Moreover, spectrum shaping materials can be furnished in powder form or metallic foil to surround the caplets arrayed in a column in the central axis of the cylinder. One class of spectrum shaping material is the oxides of strong thermal neutron absorbers erbium oxide and/or europium oxide or each in metal form or in combination as foils. The other class is spectrum shaping materials are the moderating materials to reduce the energy of the fast neutron groups to the productive epi thermal energy groups. These materials are metallic hydrides or deuterides or hydrides or deuterides of the lanthanide group.

The inner target, the subject of this application, are caplets enclosing radium-226 as sealed sources and further enclosed by nested cylinders enclosing the caplets, and jacketed by an outer enclosure that isolates the inner target from the reactor's coolant. The exterior jacket is not the subject of this application for patent. The jacket or rig may contain a cover gas that is circulated in conduits in a closed loop out of the core to shielded and instrumented compartments that monitor the cover gas. The closed loop circulates the cover gas through instrumented radon-222 traps. If radon gas escapes from the sealed inner cylinders, will be contained by the outer jacket and the instrumentation examining the cover gas will provide adequate warning to the reactor operator if troublesome quantities of radon-222 are detected. When radon-222 decays it emits gammas at the 0.511 MeV lines which is the same line as positron emission. Thus, positron emission detection equipment is readily available. The gamma detectors are located proximate to the part of the loop containing activated charcoal traps. If one trap detector shows gamma emissions at this energy, then the other trap receives the cover gas for an interval and the decay rate of the counts in the second trap will reveal if radon-222 is present by its signature decay pattern.

During neutron irradiation of radium-226, the actinium-227 “grows in” at rates which slow over time. Because the half-life of actinium-227 is almost 22 years, the irradiation period can be relatively lengthy but the longer the irradiation period; the more actinium-228 is produced, even with the spectrum tailoring. The production curve begins to fall off because actinium-227 atoms become more common setting the stage for more actinium-228 to be co-produced. The optimal period of irradiation is a function of attributes of production reactors, neutron flux, the flux tailoring of the interacting neutron energy groups and the reactor operator's pre-set schedule for reactor up time and down time.

The neutronic attributes of various existing production reactors are known and the flux tailoring needed for enhanced production varies from production reactor to production reactor. Depending on the volume of the target position and thus the target and the characteristics of the neutron flux at the reactor position where the target is to be irradiated, the radium-226 compounding agents are selected, and the density of the radium-226 atoms is determined, the radium-226 containing compacted carbonate disks and the caplets are sized. The caplets enclose the compacted powder and are joined in the hot cell and welded shut. The caplets are disk shaped and are designed to hold the helium-4, radon-222 radium-226 in the central axis region of the sealed target vessel. The radium-226 containing compound can be placed in a set of four to sixty four caplet disks to reduce the amount of radon-222 that could escape from a defect in the primary enclosure or in the welds that constitute the primary enclosure. The caplets are placed two or four at time in the next metallic or ceramic enclosure and these enclosures are placed in the central axis of the nested cylinders and redundantly enclosed with end caps that are welded shut.

The most favorable ceramic material for heat transport in the radium-226 containing powder is finely powdered passivated aluminum nitride. Heat conducting ceramic aluminum nitride provides advantages in the sealed capsule because heat is spread when the material is present with the material being irradiated.

This design reduces risks that a significant radon leak will occur during irradiation that could require a reactor shut down and removal of the leaking target. Any radon released from the target does not leak into the reactor environment because the target is isolated in the jacket that surrounds the target. This jacket contains a circulating cover gas that is monitored for radon-222. A failing target can be removed from the reactor safely being kept inside the jacket.

This application reveals and discloses the details of the inner sealed target assembly that reduces risks of radon release. The radium-226 target is to be used ideally within an enclosing jacket with an instrumented loop with circulating cover gas to detect a radon leak.

### Objects and Advantages of the Invention

The object of the present invention is to provide a more efficient inner sealed production capsule used with an exterior jacket to isolate the capsule in case a radon leak occurs during irradiation. Actinium-227 will be produced in quantity to make radium-223 and thorium-227 and thorium-228 will be co produced which is a precursor of lead-212.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a graph illustrating the neutron capture cross section of radium-226, showing a favorable production region where several neutron capture cross section peaks exceed 100 barns in the resonance region of the epithermal spectrum for radium-226 and supporting the proposition that the integral of the epithermal region provides more extensive probabilities for neutron capture by radium-226 and thus actinium-227 production than the less energetic thermal neutron energy spectrum provides.

FIG. 2 is a graph depicting the neutron capture cross section of actinium-227, showing a comparatively high affinity for thermal neutrons by nuclei of actinium-227, wherein the capture cross section peaks in the thermal spectrum at approximately 3000 barns but the neutron capture cross section becomes progressively lower than 10 barns as neutron energies increase from 40 Ev.

FIG. 3 is a graphic overlay of the plot showing neutron capture by radium-226 over that for actinium-227, demonstrating the advantages in using neutrons more energetic than 40 electron volts to irradiate radium-226, at which energy neutron captures by actinium-227 are approximately significantly less probable, as are neutron captures by radium-226 at this energy. (At thermal energies the converse is true).

FIG. 4 is a graph depicting the thermal capture cross section of representative strong thermal neutron absorbing isotopes in the following approximate ranges: erbium-167 10,000 barns, europium-151 20,000 barns.

FIG. 5A is a highly schematic front perspective view showing the inventive production vessel.

FIG. 5B is a schematic cross-sectional side view in elevation thereof, wherein the particles used as radon absorbing media are silver exchanged zeolite and activated charcoal.

FIG. 6A is an upper perspective view showing a single caplet (with the sealed enclosure shown in phantom).

FIG. 6B is a cross sectional side view in elevation thereof;

FIG. 7A is a cross-sectional side view in elevation showing an array of eight caplets; and

FIG. 7B is a cross-sectional view thereof.

### DETAILED DESCRIPTION OF THE INVENTION

Novel means to efficiently produce radium-223 and thorium-227 from radium-226 are disclosed. As is known by persons familiar with the art, the steps disclosed in the literature that are involved in production of radium-223 and thorium-227 are rather limited and straight forward. The unstable “grandparent isotope”, the “starter”, is radium-226. This is a very rare isotope and must be conserved as much as possible. On a single neutron capture radium-226 is transmuted to radium-227 that promptly decays to actinium-227, becoming the valuable product.

It is well known that, actinium-227 avidly captures thermal neutrons and by this second neutron capture, undesirable actinium-228 is co-produced. The methods disclosed in this application provide for a better conversion of radium-226 to actinium-227 with reduced co-production of unwanted actinium-228 along with ways to manage radon-222 that is constantly generated by the decay of radium-226. Using the various techniques disclosed in this application at the same time in the same target allow more pure product is generated with less consumption of radium-226 and more importantly with lower risks of incidents associated with radium-222 release. So long as one or more grams of radium-226 target can be irradiated simultaneously in the novel nested cylinder target, more economic use of reactor spaces for irradiation is promoted. Provided the higher epithermal energy groups in selected reactor spaces can be fully utilized, the new geometry target will provide efficient service. It is the use of geometry and materials to trap radon-222 with other materials to capture thermal neutrons and other materials that moderate fast neutrons to epithermal energy groups in a novel geometry of four or more enclosures that make this actinium-227 production target both economically competitive and innovative.

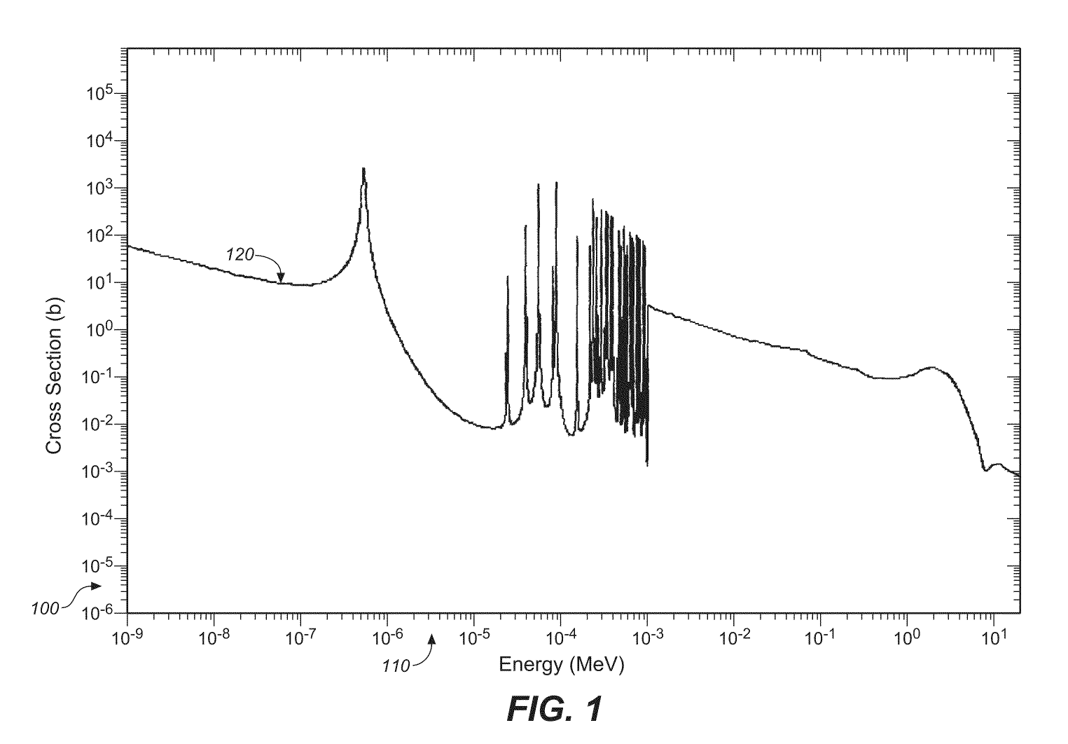

Turning now to the drawings, FIG. 1 depicts the neutron capture cross section of radium-226. The vertical axis 100 shows the probability for neutron capture in barns. The horizontal axis 110 shows the energy range of the neutrons. The plot 120 shows the neutron capture cross-section in barns for the range of neutron energy groups depicted. The plot reveals a resonance region for neutron capture in the higher epi-thermal energy range between 20 eV and 1 KeV. There is a peak for neutron capture in the thermal region at 0.5 eV.

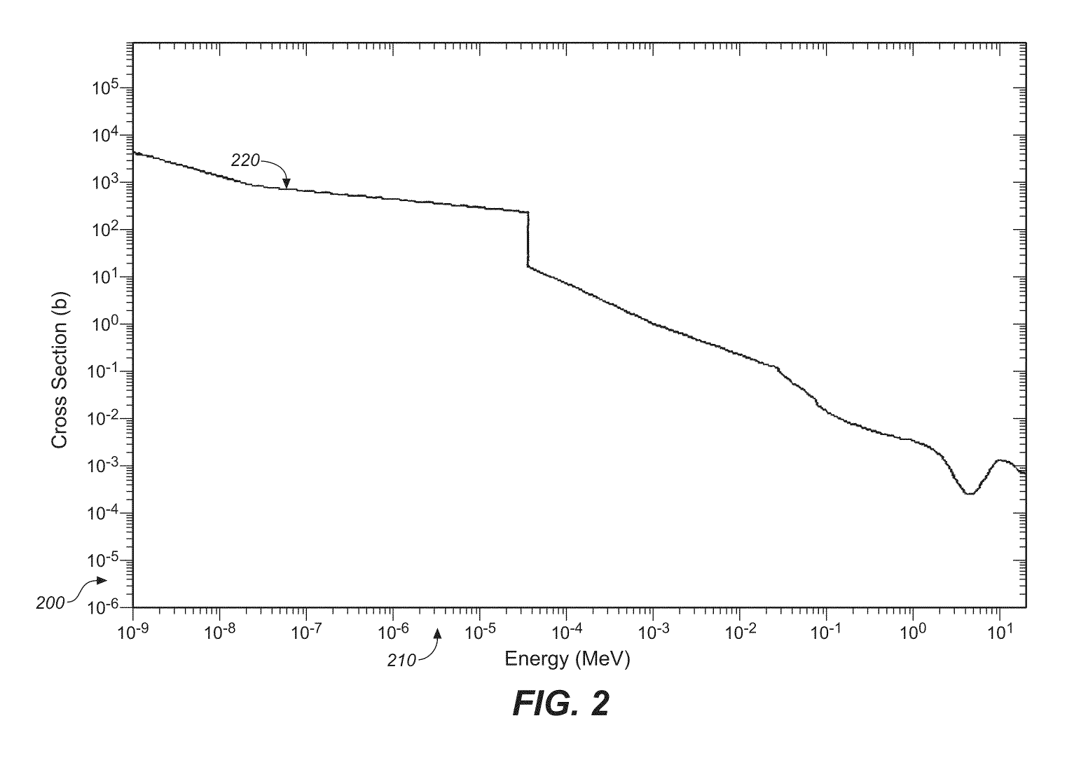

Turning now to FIG. 2, this graph depicts the neutron capture cross section of actinium-227. The vertical axis 200 shows the probability for neutron capture in barns. The plot 220 shows the neutron capture cross section in barns for the range of neutron energy groups depicted. The plot reveals a trend: the lower the energy of the neutron the more likely actinium-227 will capture a neutron. After actinium-227 captures a neutron it quickly decays to thorium-228. These captures can be reduced or increased by the use of the techniques disclosed in this application. The best configuration reduces neutron capture by actinium-227.

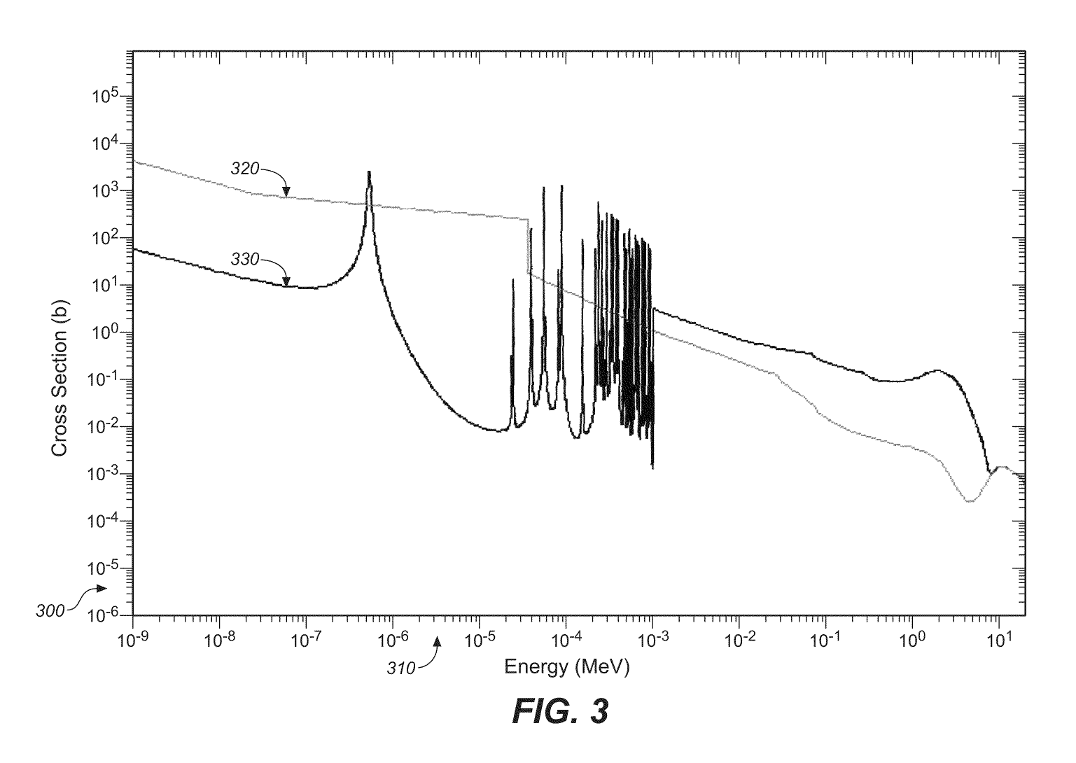

Tuning now to FIG. 3, the plots of FIG. 1 and FIG. 2 are presented together, superimposed upon each other. The vertical axis 300 shows the capture cross section in barns, the horizontal axis 310 the energy of the neutrons, 320 the neutron capture cross section of actinium-227 and 330 the neutron capture cross section of radium-226. The overlay reveals that below 20 eV the capture cross section of actinium-227 exceeds that of radium-226. The information depicted on FIG. 3 shows the importance of shaping the neutron spectrum in the actinium-227 production device, which in the manner of the preferred embodiment involve reduction the target material to neutrons with energies of less than 20 eV.

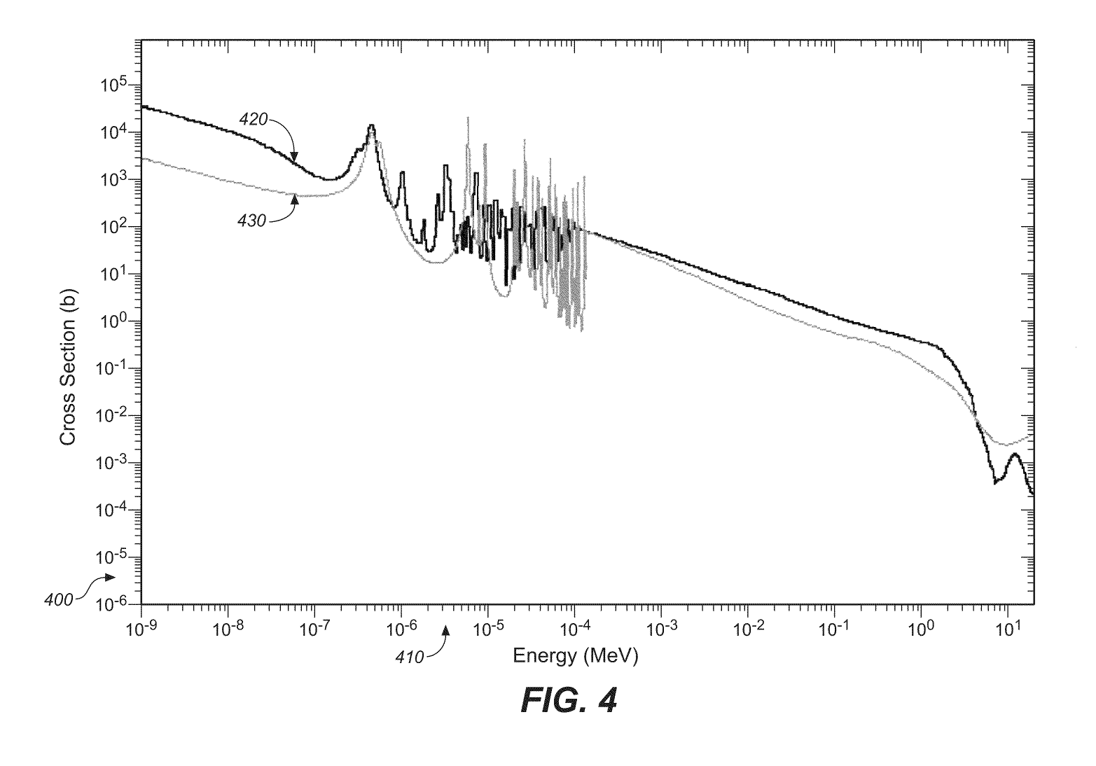

Turning to FIG. 4, plots are provided of the neutron capture cross-section of strong neutron absorbers, europium-151 and erbium-167. The vertical axis 400 shows the capture cross section in barns, the horizontal axis 410 shows the energy of the neutrons and the neutron capture cross section of europium-151 420 and erbium-167 430. This strong neutron absorber absorbs neutrons in the energy groups below 50 eV. This strong neutron absorbers used singly or together will shield the target material from lower energy neutrons. The target can be engineered using one or both of these strong neutron absorbers in the vicinity of the target material that contains radium-226. The fewer lower energy neutrons the actinium-227 produced from radium-226 “sees” the less unwanted thorium-228 will be produced.

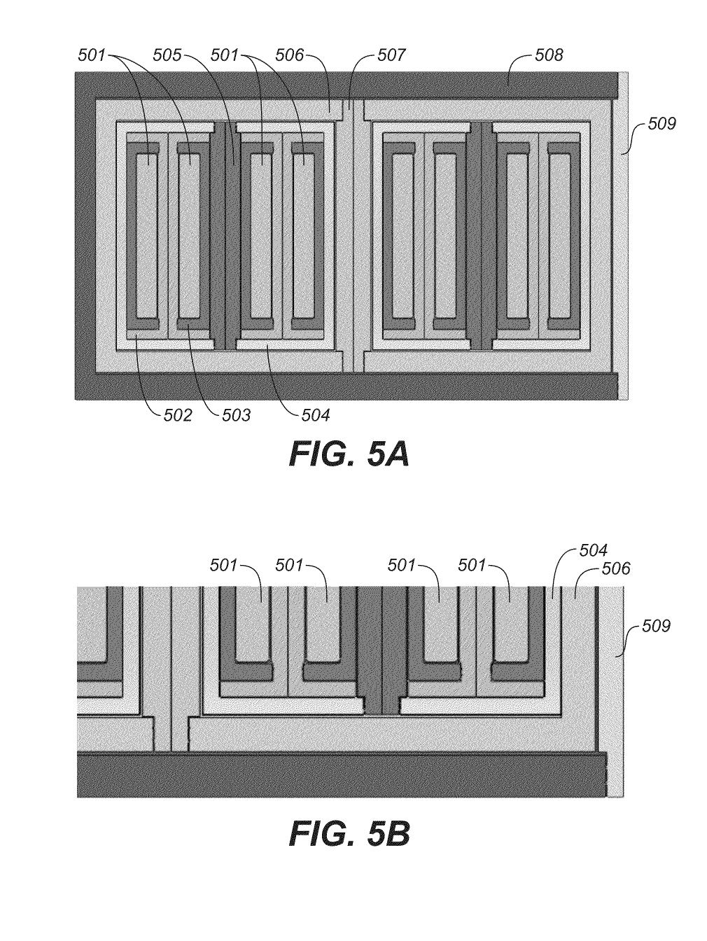

Turning next to FIG. 5A, the novel target is depicted. The geometry disclosed is a set of redundant enclosures to encapsulate radium-226 in carbonate form. The enclosures make a radon-222 tight seal so the risks of radon-222 release are significantly reduced. This figure provides detail of the components of the novel target. Detail 501 is the enclosed radium-226 carbonate containing matrix or other radium-226 containing compound. The radium-226 501 is enclosed by eight caplets in this figure. The caplets include a top or caplet cover 502 over a bottom or caplet cup 503. These components are welded shut after the cup is loaded with a measured quantity of radium-226 carbonate or other radium-226 compound. The caplets are enclosed by the caplet pair cup 504, which is welded to the caplet pair cover, lid or top 505. The caplet pair is enclosed by the two pair cup 506, which is welded to the two pair lid top or cover 507. Both two pair enclosures are enclosed by the exterior container 508 which is welded to its cover lid or top 509.

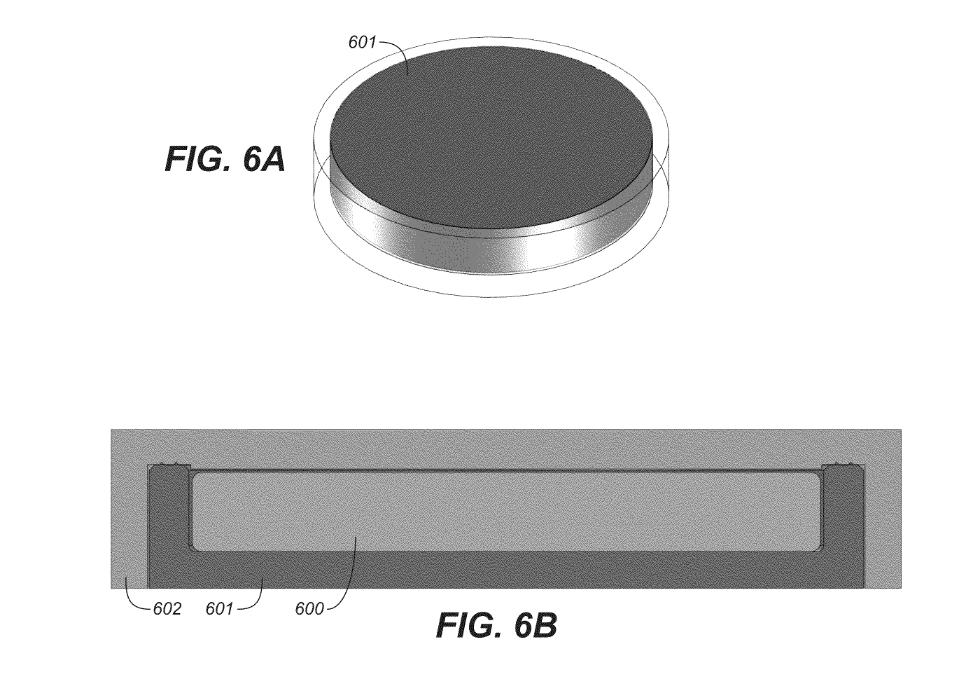

Turning now to FIG. 6A the detail of the caplet is depicted. The radium-226 carbonate or other radium-226 containing compound is shown as 600 [colored green]. The bottom or cup component of the caplet is shown as 601 [colored blue]. The top, cover or lid component of the caplet is shown as 602 [colored purple]. After the radium-226 compound is measured and loaded in the cup, the lid is welded to the cup. FIG. 6B shows the caplet after it is welded to make a radon-222 tight seal. The enclosure can be fabricated from a selected metal or alloy to provide a sealed source that encloses radium-226.

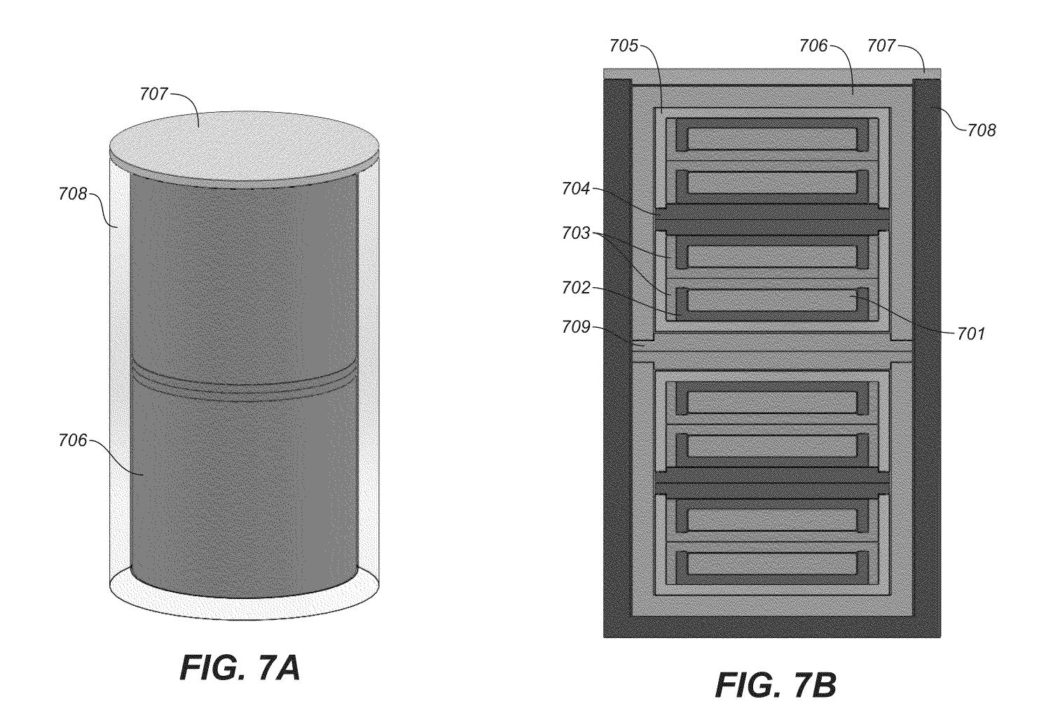

Turning now to FIGS. 7A and 7B, the target assembly for eight caplets is depicted. The exterior view and cutaway versions are provided. The cut-away shows the radium-226 carbonate 701 inside of the caplet cups 702 and lids 703, which are enclosed by the pair cup 705 and the pair cup lid 704, which are enclosed by the two pair cup 706 and the two pair lid 709, both of which are enclosed by the exterior can 708 and the exterior lid 707.

The invention disclosed in this application overcomes the obstacles encountered in producing radium-223 and thorium-227 from radium-226. These obstacles have limited radium-223's and thorium-227's availability for therapeutic uses. This application discloses and reveals a novel production vessel or target enabling the commercial production of uniform radium-223 and thorium-227 from actinium-227.

The new production target addresses important production concerns. The first production concern involves radon-222 gas leaks. Radium-226 constantly generates radon-222 as it decays. This decay product, radon-222, decays to polonium-218 in 3.8 days which promptly decays to lead-210 with a 22 year half-life. Depending on the mass of radium-226 in the target and the gas pressure and temperature in the target, a significant volume of radon-222 will be present in the sealed capsule at all times. The radon-222 gas decays away as it is formed when it is in secular equilibrium. Radon-222 reaches secular equilibrium in approximately 11.4 days.

When the caplets are opened after irradiation for the separation of actininium-227 produced from radium-226 and the other isotopes, inert radon gas could escape and must be captured. Radon contamination raises potential exposure issues. To reduce risks of exposure to radon-222 during irradiation or during the post irradiation separations process, the caplet and the cylinders enclosing radium-226 (target) can contain a selected radon trapping agent silver washed zeolite or activated charcoal.

The new production target addresses important production issues. The first production issue managed is radon. Multiple enclosures and multiple caplets reduce risk of a radon incident. Use of a jacket with circulating cover gas that is monitored for radon that has escaped from the multiple walls manages a radon leak incident so that the isolated target can be removed from the reactor. Radium-226 constantly generates radon-222 as it decays. This decay product, radon-222, decays to polonium-218 in 3.8 days which promptly decays to lead-210 with a 22 year half-life. Depending on the mass of radium-226 in the target and the gas pressure and temperature in the target, a significant volume of radon-222 will be present in the sealed capsule at all times. The radon-222 gas decays away as it is formed when it is in secular equilibrium. Radon-222 reaches secular equilibrium in approximately 11.4 days. The risks are reduced by the use of redundant enclosures and the uncertainty is managed by the use of the instrumented jacket.

The leading and preferred embodiment of the invention successively encloses radium-226 in powdered but compacted “diluted” carbonate form to produce actinium-227 by epithermal neutron capture in a tailored neutron spectrum. This novel type of production device can be considered for the production of other reactor-made isotopes by single or successive neutron capture. The novel techniques are tailoring the neutron spectrum using various materials, reducing self shielding by reduction of the target atom density, and better materials control using stacked caplets in nested cylinder geometry. The features common to all embodiments are multiple, nested metal or ceramic tubular “radon-tight” enclosures to provide redundant barriers to significantly lower the risk of radioactive gases escaping from the caplets during irradiation or during transport of the target. The use of multiple nested tubes, having each end welded shut, enclosing the caplets provides barrier redundancy. The design reflects the use of a small disk shaped metal containers called caplets which are welded shut to enclose the compacted, powdered material to be irradiated. Each caplet is welded shut and placed in a second enclosure. Then several enclosed caplets are placed in a metal tube that is welded shut. This tube is enclosed by the final outer enclosure that is welded shut or by additional tubes. The use of redundant enclosures raises no heat transport issues, as there are no air gaps between the nested metal enclosures. The metals to be used are qualified stainless steel HT-9, SS-316, qualified zirconium alloy, zircalloy, qualified titanium alloy, or aluminum alloy such as aluminum 6061. Further, silicon carbide tubulars or other ceramics can be fashioned to be radon tight. Combinations are possible as well with the caplets being one alloy and the tubing another. In all of the embodiments made possible by this disclosure, the heat spreading material used is passivated aluminum nitride which is mixed with the material to be irradiated radium-226 carbonate which media is then compacted. Further, in many embodiments the fine, granular ceramic heat conduction material is mixed with the granular target material which is compacted before that caplet is filled. This mix transports heat from the irradiated material to the nested metal or ceramic tubular enclosures. The dilutant or dispersant, the powdered or granular heat transporting material, spreads heat following neutron capture. The heat generated by the action of neutrons can be transported and dissipated by powdered passivated aluminum nitride in the caplets. Accordingly, radium-226 can be exposed to neutron fluxes that would cause overheating but for the use of the heat conducting ceramic grains. Importantly, the spaces between the grains of the compacted powder or granular composition provide a plenum volume for gasses released by decay. In this way, internal gas pressures are managed, keeping the gas pressure within the target well within safety margins before, during and after irradiation.

The granular ceramic heat conducting material is mixed with the material selected for irradiation. The ceramic reduces the percentage of or density of the atoms comprising the target material to be irradiated reducing self shielding effects, the ceramic also provides the benefit of heat transport when mixed with target material as needed. The heat conducting material can be aluminum nitride or other chemically inert and neutronically inert material that conducts heat well. An alternate embodiment would use passivated aluminum metal particles that have been treated to have a thin oxidized surface or a thin nitrided surface. Use of passivated metallic particles will increase heat transport over the ceramic. Passivation is important to reduce the pyrophoric properties of finely divided aluminum particles.

Each of the ceramic or metal tubes is capped and welded shut to provide redundant gas-tight enclosures so that risks of leakage of radon-222 from the capsule to the enclosing jacket or the environment are reduced to the negligible level. There are not less than four gas tight compartments that are welded shut enclosing the target material. The first compartment is the inner caplet that encloses the granular mix of compacted material that is to be irradiated and the heat spreading material if needed. The inner caplet is enclosed by the outer caplet. There are a total of eight caplets shown in the drawings positioned end to end but the number of caplets can be increased provided the final geometry is compatible with the reactor position indicated for the irradiation of that target material. Enclosing the caplets are the sealed ceramic silicon carbide or metallic tubes that are welded shut.

The redundant geometry provides leak tight barriers that retain radon and helium, the gasses generated by the decay of radium-226 and its decay daughters. The novel target enclosure has at least four barriers between the reactor spaces on the outside of the target and the material to be irradiated inside the caplets located the central axis of the target. The central axis is where the caplets containing the various target material are located.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. An actinium-227 production device, comprising:
a plurality of metallic or ceramic caplets enclosing radium-226-containing material enclosed redundantly by nested sealed cylinders, wherein said radium-226-containing material is radium-226 carbonate or another radium-226 compound compacted into a disk and diluted with heat transporting ceramic materials;
a thermal neutron shield including spectrum shaping materials to protect actinium-227 produced from exposure to thermal neutrons; and
a strong neutron absorber;
wherein the thermal neutron absorber and the strong neutron absorber shape the neutron spectrum such that said radium-226-containing material is exposed to neutrons in the higher epithermal energy groups between 20 eV and 1 KeV.

2. The actinium-227 production device of claim 1, wherein said caplets have a cross-sectional geometric shape selected from the group consisting of disk-shaped, hexagonal, octagonal, square, and rectangular.

3. The actinium-227 production device of claim 1, further including an exterior jacket including a radon trapping matrix.

4. The actinium-227 production device of claim 3, wherein said radon trapping matrix is fabricated from a silver exchanged zeolite.

5. The actinium-227 production device of claim 3, wherein said radon trapping matrix is fabricated from metallurgical grade activated charcoal

6. The actinium-227 production device of claim 1, wherein said radon trapping matrix is fabricated from a combination of a silver exchanged zeolite and a metallurgical grade activated charcoal.

7. The actinium-227 production device of claim 1, wherein said strong neutron absorber and said thermal neutron shield are powdered or solid europium-151 or erbium-167.

8. The actinium-227 production device of claim 1, wherein said thermal neutron shield is selected from the group consisting of natural europium and erbium oxide powder.

9. The actinium-227 production device of claim 1, wherein The selected neutron spectrum shaping hydrides are calcium hydride, zirconium hydride, yttrium hydride or vanadium hydride in the outermost cylinder.

10. The actinium-227 production device of claim 1, wherein up to two grams of radium-226 can be irradiated at one time in one target to produce actinium-227.

11. A method of producing actinium-227 from radium-226 to reduce production of unwanted actinium-228 from actinium-227, said method comprising the steps:
(a) providing a plurality of metallic or ceramic caplets enclosing radium-226-containing target material enclosed redundantly by nested sealed cylinders, wherein said radium-226-containing material is radium-226 carbonate or another radium-226 compound compacted into a disk and diluted with heat transporting ceramic materials;
(b) a thermal neutron shield including spectrum shaping materials to protect actinium-227 produced from exposure to thermal neutrons;
(c) a strong neutron absorber; and
(d) exposing the target material to neutrons, wherein the strong neutron absorber shapes the neutron spectrum such that neutrons reaching the target material are in the higher epithermal energy groups and have an energy between 20 eV and 1 KeV.

12. The method of claim 11, wherein step (b) involves providing spectrum-shaping materials made from hydrides of calcium, zirconium, yttrium, or vanadium in powder form.

13. The method of claim 11, wherein step (a) involves using 4 to 64 caplets to segregate radium-226 containing materials.

14. The method of claim 11, wherein step (a) involves using radium-226 carbonate as the radium compound to irradiate.

15. The method of claim 11, further including the step of using aluminum nitride powder to distribute heat in the target material.

16. The method of claim 11, further including the step of using cubic boron arsenide powder to spread heat in the target material.

17. The method of claim 11, wherein step (a) involves using silicon dioxide powder to dilute radium-226 carbonate as the target material.

18. The method of claim 11, wherein step (a) includes providing caplets sealed with welds to reduce the risk of radon-222 escape from the target material.

19. An actinium-227 production apparatus, comprising: at least three sealed and nested metal or ceramic cylinders, each of said cylinders enclosing an inner set of caplets of smallest diameter containing compacted disks of radium-226 carbonate and radon trapping media, said cylinders including a middle diameter cylinder enclosing a set of smallest diameter radium compound and radon trapping media cylinders, and further including strong thermal neutron absorbers comprising a thermal neutron shield, and wherein a largest diameter cylinder encloses the smaller diameter nested cylinders and containing additional radon trapping media, and selected hydride powders to moderate fast neutrons to epithermal energy ranges.

20. The actinium-227 production apparatus of claim 19, wherein said nested cylinders are made of aluminum 6061, stainless steel 316, HT-9 zircalloy, or titanium alloy.
